(19) United States
(12) Patent Application Publication
(10) Pub. No.: US 2025/0290874 A1
(43) Pub. Date: Sep. 18, 2025

(54) IMAGING CONTROL DEVICE, IMAGING CONTROL METHOD, AND IMAGING CONTROL PROGRAM

(71) Applicant: FUJIFILM CORPORATION, Tokyo (JP)

(72) Inventor: Shin HAMAUZU, Kanagawa (JP)

(21) Appl. No.: 19/057,999

(22) Filed: Feb. 20, 2025

(30) Foreign Application Priority Data
Mar. 12, 2024 (JP) 2024-037898

(51) Int. Cl. G01N 23/04

(52) U.S. Cl. CPC G01N 23/043; G01N 2223/076; G01N 2223/306; G01N 2223/406; G01N 2223/612

(57) ABSTRACT

A processor is configured to: register the fluoroscopy apparatus of which the processor controls the fluoroscopy and another fluoroscopy apparatus other than the fluoroscopy apparatus in association with each other; notify the other fluoroscopy apparatus of an imaging condition with the pulsed radiation in a case where an instruction to start emitting radiation is given in the fluoroscopy apparatus of which the imaging control device controls the fluoroscopy; and control, in a case where the imaging condition is notified from the other fluoroscopy apparatus in a case where the instruction to start emitting the radiation is not given in the fluoroscopy apparatus of which the imaging control device controls the fluoroscopy, and the instruction to start emitting the radiation is given, the fluoroscopy to emit the pulsed radiation, at timing at which the emission of the pulsed radiation is stopped in the other fluoroscopy apparatus based on the imaging condition.

### CROSS REFERENCE TO RELATED APPLICATIONS

The present application claims priority from Japanese Patent Application No. 2024-037898, filed on Mar. 12, 2024, the entire disclosure of which is incorporated herein by reference.

### BACKGROUND

### Technical Field

The present disclosure relates to an imaging control device, an imaging control method, and an imaging control program.

### Related Art

In surgical operations and catheter treatment, it is necessary to ascertain a positional relationship between surgical instruments and human body structures such as bones and blood vessels. Therefore, during operation, a subject is imaged by a fluoroscopy apparatus, and the positional relationship between the surgical instrument and the human body structure is ascertained using a fluoroscopic image of radiation displayed on a display by the imaging. However, the surgical instrument and the human body structure have a three-dimensional positional relationship, whereas the fluoroscopic image is a two-dimensional image. Even in a case of viewing such a two-dimensional fluoroscopic image, it is difficult to ascertain a three-dimensional positional relationship between the surgical instrument and the human body structure.

Therefore, a fluoroscopy apparatus that comprises two sets of detection units and radiation sources and performs imaging on a subject in two directions to ascertain a three-dimensional positional relationship between a surgical instrument and a human body structure has been proposed (see JP2019-087892A). In the apparatus disclosed in JP2019-087892A, a timing of performing imaging is controlled such that a period in which the first detection unit of the two detection units is irradiated with radiation and a period in which the second detection unit thereof is irradiated with radiation do not overlap each other.

On the other hand, imaging is also performed from two directions with respect to the subject by using two fluoroscopy apparatuses (see JP2015-009012A). In the apparatus disclosed in JP2015-009012A, the irradiation timings of the two X-ray emitting units are alternately output from the control device, and the X-ray imaging is performed from two different directions by shifting the X-ray irradiation timings of the two X-ray emitting units.

In a case where two fluoroscopy apparatuses are used, radiation emitted to the subject from one apparatus may be scattered by the subject, resulting in unintended radiation being detected by the other apparatus. In this case, the image quality of the fluoroscopic images acquired by both the apparatuses is degraded. In the method described in JP2015-009012A, the timings of the X-ray irradiation by the two X-ray emitting units are shifted. However, in the method disclosed in JP2015-009012A, imaging is performed by the other fluoroscopy apparatus even at a timing at which only one fluoroscopy apparatus is used. In addition, in the method disclosed in JP2015-009012A, in a case where the imaging by one fluoroscopy apparatus is started and then the imaging by the other fluoroscopy apparatus is started, the timing of the X-ray irradiation cannot be set.

### SUMMARY OF THE INVENTION

The present disclosure has been made in view of the above circumstances, and an object of the present disclosure is to reduce an influence of radiation emitted from another fluoroscopy apparatus in a case where fluoroscopy is performed at timings different from each other using a plurality of fluoroscopy apparatuses.

An imaging control device according to the present disclosure controls fluoroscopy of a subject with a pulsed radiation from a plurality of directions, in each of a plurality of fluoroscopy apparatuses used simultaneously, in a case of performing the fluoroscopy, the imaging control device comprises:
at least one processor, and
the processor is configured to:
   register the fluoroscopy apparatus of which the processor itself controls the fluoroscopy and another fluoroscopy apparatus other than the fluoroscopy apparatus in association with each other;
   notify the other fluoroscopy apparatus of an imaging condition with the pulsed radiation in a case where an instruction to start emitting radiation is given in the fluoroscopy apparatus of which the processor itself controls the fluoroscopy; and
   control, in a case where the imaging condition is notified from the other fluoroscopy apparatus in a case where the instruction to start emitting the radiation is not given in the fluoroscopy apparatus of which the processor itself controls the fluoroscopy, and then the instruction to start emitting the radiation is given, the fluoroscopy to emit the pulsed radiation, at a timing at which the emission of the pulsed radiation is stopped in the other fluoroscopy apparatus, based on the imaging condition.

In the imaging control device according to the present disclosure, the processor may be configured to:
set the fluoroscopy apparatus of which the imaging control device itself controls the fluoroscopy to a registration standby state;
search for the other fluoroscopy apparatus in a registration standby state; and
register the fluoroscopy apparatus of which the processor itself controls the fluoroscopy and the found other fluoroscopy apparatus in association with each other.

In addition, in the imaging control device according to the present disclosure, the instruction to start emitting the radiation may be given by turning on a radiation irradiation switch of the fluoroscopy apparatus.

In addition, in the imaging control device according to the present disclosure, the processor may be configured to notify, in a case where an instruction to stop emitting the radiation is given, the other fluoroscopy apparatus that the emission of the radiation is stopped.

In addition, in the imaging control device according to the present disclosure, the instruction to stop emitting the radiation may be given by turning off a radiation irradiation switch of the fluoroscopy apparatus, and
the processor is configured to notify the other fluoroscopy apparatus that the emission of the radiation is stopped by transmitting a radiation emission stop flag to the other fluoroscopy apparatus.

In addition, an imaging control method according to the present disclosure is an imaging control method for controlling fluoroscopy of a subject with a pulsed radiation from a plurality of directions, in each of a plurality of fluoroscopy apparatuses used simultaneously, in a case of performing the fluoroscopy, and the method comprises:
via a computer,
registering the fluoroscopy apparatus of which the computer itself controls the fluoroscopy and another fluoroscopy apparatus other than the fluoroscopy apparatus in association with each other;
notifying the other fluoroscopy apparatus of an imaging condition with the pulsed radiation in a case where an instruction to start emitting radiation is given in the fluoroscopy apparatus of which the computer itself controls the fluoroscopy; and
controlling, in a case where the imaging condition is notified from the other fluoroscopy apparatus in a case where the instruction to start emitting the radiation is not given in the fluoroscopy apparatus of which the computer itself controls the fluoroscopy, and then the instruction to start emitting the radiation is given, the fluoroscopy to emit the pulsed radiation, at a timing at which the emission of the pulsed radiation is stopped in the other fluoroscopy apparatus, based on the imaging condition.

An imaging control program according to the present disclosure is an imaging control program that causes a computer to execute a process of controlling fluoroscopy of a subject with a pulsed radiation from a plurality of directions, in each of a plurality of fluoroscopy apparatuses used simultaneously, in a case of performing the fluoroscopy, and the imaging control program causes a computer to execute:
a process of registering the fluoroscopy apparatus of which the computer itself controls the fluoroscopy and another fluoroscopy apparatus other than the fluoroscopy apparatus in association with each other;
a process of notifying the other fluoroscopy apparatus of an imaging condition with the pulsed radiation in a case where an instruction to start emitting radiation is given in the fluoroscopy apparatus of which the computer itself controls the fluoroscopy; and
a process of controlling, in a case where the imaging condition is notified from the other fluoroscopy apparatus in a case where the instruction to start emitting the radiation is not given in the fluoroscopy apparatus of which the computer itself controls the fluoroscopy, and then the instruction to start emitting the radiation is given, the fluoroscopy to emit the pulsed radiation, at a timing at which the emission of the pulsed radiation is stopped in the other fluoroscopy apparatus, based on the imaging condition.

According to the present disclosure, it is possible to reduce an influence of radiation emitted from another fluoroscopy apparatus in a case where fluoroscopy is performed at timings different from each other using a plurality of fluoroscopy apparatuses.

### BRIEF DESCRIPTION OF THE DRAWINGS

FIG. 1 is a diagram showing an overview of a fluoroscopy system including a plurality of fluoroscopy apparatuses each equipped with an imaging control device according to an embodiment of the present disclosure.

FIGS. 2A and 2B are diagrams showing a positional relationship between first and second fluoroscopy apparatuses.

FIG. 3 is a diagram showing a schematic configuration of the imaging control device according to the present embodiment.

FIG. 4 is a diagram showing a functional configuration of the imaging control device according to the present embodiment.

FIG. 5 is a diagram illustrating a timing of irradiation with radiation.

FIG. 6 is a diagram showing a display screen of fluoroscopic images.

FIG. 7 is a flowchart showing processing performed in the present embodiment.

FIG. 8 is a flowchart showing registration processing performed in the present embodiment.

FIG. 9 is a flowchart showing processing performed in the fluoroscopy apparatus on a side to which the imaging condition is notified in the present embodiment.

### DETAILED DESCRIPTION

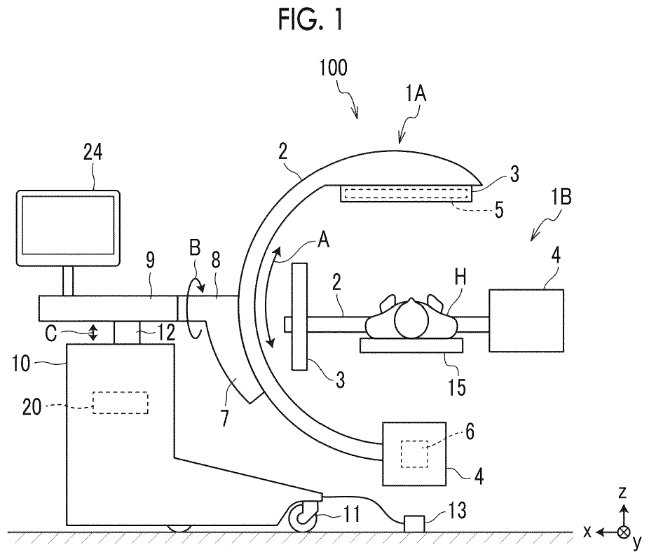

Hereinafter, embodiments of the present disclosure will be described with reference to the drawings. FIG. 1 is a schematic block diagram showing a configuration of a fluoroscopy system including a plurality of fluoroscopy apparatuses each equipped with an imaging control device according to an embodiment of the present disclosure. As shown in FIG. 1, a fluoroscopy system 100 according to the present embodiment comprises first and second fluoroscopy apparatuses 1A and 1B that are used simultaneously.

As shown in FIG. 1, the first fluoroscopy apparatus 1A according to the present embodiment comprises a C-arm 2. A detection unit 3 is attached to one end part of the C-arm 2, and a radiation emitting unit 4 is attached to the other end part of the C-arm 2 to face the detection unit 3. The second fluoroscopy apparatus 1B has a configuration similar to that of the first fluoroscopy apparatus 1A. However, only the C-arm 2, the detection unit 3, and the radiation emitting unit 4 are shown in FIG. 1, and other components are not shown.

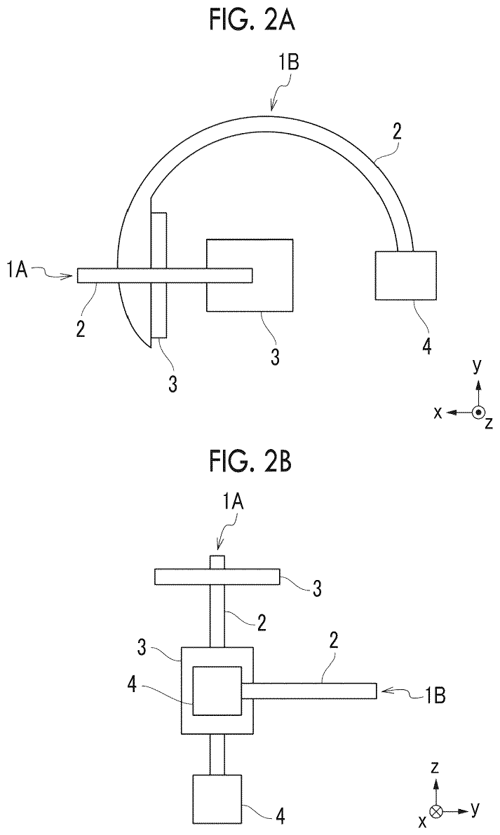

FIGS. 2A and 2B are diagrams showing a positional relationship between the first and second fluoroscopy apparatuses 1A and 1B. In the present embodiment, it is assumed that an x-axis is set in a left-right direction of FIG. 1, a y-axis is set in a depth direction of FIG. 1, and a z-axis is set in a direction perpendicular to a surface on which the first and second fluoroscopy apparatuses 1A and 1B shown in FIG. 1 are placed. FIG. 2A shows a state in which the fluoroscopy system 100 is viewed in the z direction, and FIG. 2B shows a state in which the fluoroscopy system 100 is viewed in the x direction. In the states shown in FIGS. 1 to 2B, the first fluoroscopy apparatus 1A is disposed to capture an image of a subject H in the z direction, and the second fluoroscopy apparatus 1B is disposed to capture an image of the subject H in the x direction.

The configuration of the first fluoroscopy apparatus 1A will be described below in detail. Since the configuration of the second fluoroscopy apparatus 1B is the same as the configuration of the first fluoroscopy apparatus 1A, a detailed description of the second fluoroscopy apparatus 1B will be omitted.

A radiation detector 5, such as a flat panel detector, is provided in the detection unit 3. In addition, for example, a circuit board including a charge amplifier that converts a charge signal read out from the radiation detector 5 into a voltage signal, a sampling two correlation pile circuit that samples the voltage signal output from the charge amplifier, and an analog-digital (AD) conversion unit that converts the voltage signal into a digital signal is also provided in the detection unit 3. Further, in the present embodiment, the radiation detector 5 is used. On the other hand, the present embodiment is not limited to the radiation detector 5 as long as radiation can be detected and the radiation can be converted into an image. For example, a detection device such as an image intensifier can be used.

The radiation detector 5 can repeatedly perform recording and reading out of a radiation image, may be a so-called direct-type radiation detector that directly converts radiation such as X-rays into charges, or may be a so-called indirect-type radiation detector that converts radiation into visible light once and converts the visible light into a charge signal. As a method for reading out a radiation image signal, it is desirable to use the following method: a so-called thin film transistor (TFT) readout method which reads out a radiation image signal by turning on and off a TFT switch; or a so-called optical readout method which reads out a radiation image signal by irradiating a target with readout light. On the other hand, the readout method is not limited thereto, and other methods may be used.

A radiation source 6 is accommodated in the radiation emitting unit 4, and the radiation source 6 emits radiation toward the detection unit 3. The radiation source 6 emits X-rays as radiation, and a timing at which the radiation source 6 emits radiation and a timing at which the radiation detector 5 detects the radiation are controlled by an imaging controller, which will be described later. In addition, the radiation generation conditions in the radiation source 6, that is, the selection of the material of the target and the filter, the tube voltage, the irradiation time, and the like are also controlled by the imaging controller.

The C-arm 2 according to the present embodiment is held by a C-arm holding part 7 to be movable in the direction of an arrow A shown in FIG. 1, and integrally changeable in angle with respect to the detection unit 3 and the radiation emitting unit 4 in the z direction (vertical direction) shown in FIG. 1. In addition, the C-arm holding part 7 includes a shaft part 8, and the shaft part 8 rotatably connects the C-arm 2 to a bearing 9. Thereby, the C-arm 2 is configured to be rotatable in the direction of an arrow B shown in FIG. 1 with the shaft part 8 as a rotation axis.

In addition, as shown in FIG. 1, the first fluoroscopy apparatus 1A comprises a body part 10. A plurality of wheels 11 are attached to a bottom portion of the body part 10, and thus, the first fluoroscopy apparatus 1A can be moved. A support shaft 12 that is expanded and contracted in a z-axis direction of FIG. 1 is provided on an upper portion of a housing of the body part 10 in FIG. 1. The bearing 9 is held on the upper portion of the support shaft 12 to be movable in the direction of an arrow C.

In addition, a foot switch 13 for turning on and off the emission of radiation from the radiation source 6 of the radiation emitting unit 4 is connected to the body part 10. In a case where a doctor during operation steps on the foot switch 13, it is turned on, and as a result, radiation is emitted from the radiation source 6. In a case where the doctor removes his/her foot from the foot switch 13, it is turned off, and as a result, the emission of the radiation from the radiation source 6 is stopped. The foot switch 13 is an example of a radiation irradiation switch. The foot switch 13 of the first fluoroscopy apparatus 1A and the foot switch 13 of the second fluoroscopy apparatus 1B may be disposed side by side so that both of the foot switches 13 can be turned on at the same time or only one of the foot switches 13 can be turned on.

The first fluoroscopy apparatus 1A has the above-described configuration, and thus, irradiates the subject H from below the subject H who is lying on an imaging table 15 with radiation, detects the radiation transmitted through the subject H with the radiation detector 5 of the detection unit 3, and acquires a fluoroscopic image of the subject H from the front. On the other hand, the second fluoroscopy apparatus 1B irradiates the subject H from the side of the subject H who is lying on the imaging table 15 with radiation, detects the radiation transmitted through the subject H with the radiation detector 5 of the detection unit 3, and acquires a fluoroscopic image of the subject H captured from the side of the subject H. By displaying the two fluoroscopic images thus acquired with different imaging directions, it is possible to ascertain the state of the inside of the subject H in a three-dimensional manner.

Here, the C-arm 2 is movable in the direction of the arrow A, the direction of the arrow B, and the direction of the arrow C, and the first and second fluoroscopy apparatuses 1A and 1B are movable by the wheels 11. Therefore, the first and second fluoroscopy apparatuses 1A and 1B can image a desired part of the subject H who is lying on the imaging table 15 in a desired direction while adjusting their own positions and the position of the C-arm 2.

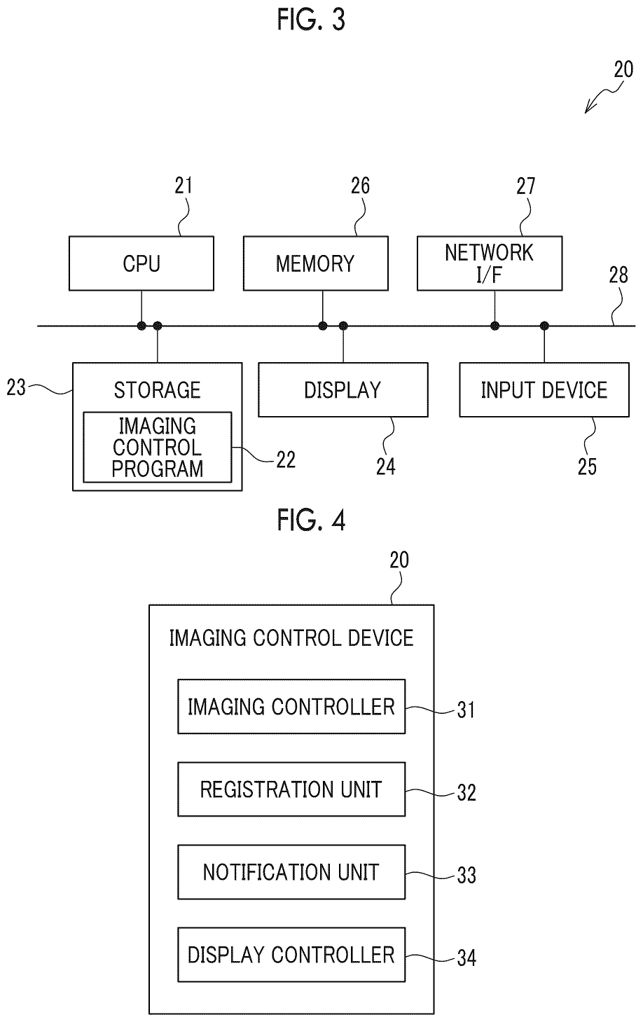

The body part 10 is provided with an imaging control device 20 according to the present embodiment for controlling the imaging of the first and second fluoroscopy apparatuses 1A and 1B. FIG. 3 is a diagram showing a hardware configuration of the imaging control device. As shown in FIG. 3, the imaging control device 20 is a computer, such as a workstation, a server computer, and a personal computer, and comprises a central processing unit (CPU) 21, a non-volatile storage 23, and a memory 26 as a temporary storage area. In addition, the imaging control device 20 comprises a display 24 such as a liquid crystal display, an input device 25 such as a keyboard and a mouse, and a wired or wireless network interface (I/F) 27 that is connected to the detection unit 3, the radiation emitting unit 4, and the foot switch 13, and is used to exchange information with external devices. The CPU 21, the storage 23, the display 24, the input device 25, the memory 26, and the network I/F 27 are connected to a bus 28. The CPU 21 is an example of a processor according to the present disclosure.

The storage 23 is realized by a hard disk drive (HDD), a solid-state drive (SSD), a flash memory, and the like. An imaging control program 22 installed in the imaging control device 20 is stored in the storage 23 serving as a storage medium. The CPU 21 reads out the imaging control program 22 from the storage 23, loads the imaging control program 22 into the memory 26, and executes the loaded imaging control program 22.

The imaging control program 22 is stored in a storage device of a server computer connected to the network or in a network storage in a state in which it can be accessed from the outside, and is downloaded to and installed on the imaging control device 20 in response to a request. Alternatively, the imaging control program 22 is recorded on a recording medium, such as a digital versatile disc (DVD) and a compact disc read-only memory (CD-ROM), and distributed, and is installed on the imaging control device 20 from the recording medium.

Next, a functional configuration of the imaging control device according to the present embodiment will be described. FIG. 4 is a diagram showing a functional configuration of the imaging control device according to the present embodiment. As shown in FIG. 4, the imaging control device 20 comprises an imaging controller 31, a registration unit 32, a notification unit 33, and a display controller 34. Then, the CPU 21 executes the imaging control program 22, so that the CPU 21 functions as the imaging controller 31, the registration unit 32, the notification unit 33, and the display controller 34.

In a case where the foot switch 13 is turned on and an on signal from the foot switch 13 is input, the imaging controller 31 causes radiation to be emitted from the radiation source 6 included in the radiation emitting unit 4 based on imaging condition set by a console (not shown). Furthermore, the imaging controller 31 detects the radiation transmitted through the subject H with the radiation detector 5 of the detection unit 3 in response to the timing at which the radiation is emitted from the radiation source 6, and generates a fluoroscopic image of the subject H. The generated fluoroscopic image is displayed on the display 24.

In the present embodiment, the imaging controller 31 causes the radiation source 6 to emit the radiation in a pulsed manner while the foot switch 13 is turned on. Accordingly, the pulsed radiation is emitted from the radiation source 6, and the fluoroscopic image is generated by the radiation detector 5 at a timing corresponding to the emission of the radiation. Therefore, the fluoroscopic images are continuously displayed on the display 24 like a motion picture at a timing corresponding to the emission of the pulsed radiation.

In addition, as will be described later, in a case where the imaging condition is notified from the other fluoroscopy apparatus, the imaging controller 31 controls the timing of the emission of the radiation of the fluoroscopy apparatus itself.

The registration unit 32 registers the fluoroscopy apparatus of which the imaging control device 20 itself controls the fluoroscopy and a fluoroscopy apparatus other than the fluoroscopy apparatus. Specifically, the registration unit 32 performs pairing with a fluoroscopy apparatus other than the fluoroscopy apparatus of which the imaging control device 20 itself controls the fluoroscopy. In the present embodiment, the registration unit 32 of the first fluoroscopy apparatus 1A performs pairing with the second fluoroscopy apparatus 1B, and the registration unit 32 of the second fluoroscopy apparatus 1B performs pairing with the first fluoroscopy apparatus 1A.

For the pairing, for example, a method similar to that of short-range wireless communication, such as Bluetooth (registered trademark), may be used. That is, pairing may be performed by making the first fluoroscopy apparatus 1A and the second fluoroscopy apparatus 1B recognize each other, and giving an instruction to perform pairing via the input device 25.

At the time of registration, a user such as a doctor or a medical assistant performs an operation for putting the apparatus itself into a registration standby state using the input device 25 for each of the first fluoroscopy apparatus 1A and the second fluoroscopy apparatus 1B. Accordingly, the registration unit 32 sets the fluoroscopy apparatus, in which the registration unit 32 itself is provided, to a registration standby state. Next, the registration unit 32 searches for another fluoroscopy apparatus in the registration standby state. For example, in the present embodiment, since both the first and second fluoroscopy apparatuses 1A and 1B are set to a registration standby state, in a case where the registration unit 32 of the imaging control device 20 of the first fluoroscopy apparatus IA searches for an apparatus in a registration standby state, the second fluoroscopy apparatus 1B is found. On the other hand, in a case where the registration unit 32 of the imaging control device 20 of the second fluoroscopy apparatus 1B searches for an apparatus in a registration standby state, the first fluoroscopy apparatus 1A is found.

The registration unit 32 of the imaging control device 20 of the first fluoroscopy apparatus 1A performs pairing with the found second fluoroscopy apparatus 1B, and registers the first fluoroscopy apparatus 1A and the found second fluoroscopy apparatus 1B in association with each other. The registration unit 32 of the imaging control device 20 of the second fluoroscopy apparatus 1B performs pairing with the found first fluoroscopy apparatus 1A, and registers the second fluoroscopy apparatus 1B and the found first fluoroscopy apparatus 1A in association with each other.

In a case where the foot switch 13 is turned on, the notification unit 33 notifies the other associatedly registered fluoroscopy apparatus of the imaging condition. That is, in a case where the foot switch 13 is turned on in the first fluoroscopy apparatus 1A, the notification unit 33 of the imaging control device 20 of the first fluoroscopy apparatus 1A notifies the second fluoroscopy apparatus 1B of the imaging condition. In a case where the foot switch 13 is turned on in the second fluoroscopy apparatus 1B, the notification unit 33 of the imaging control device 20 of the second fluoroscopy apparatus 1B notifies the first fluoroscopy apparatus 1A of the imaging condition. The notification is performed, for example, via short-range wireless communication. In the present embodiment, since the radiation is emitted from the radiation source 6 in a pulsed manner, the imaging condition include an irradiation start time, a pulse rate (pulse/s), and a pulse width (ms).

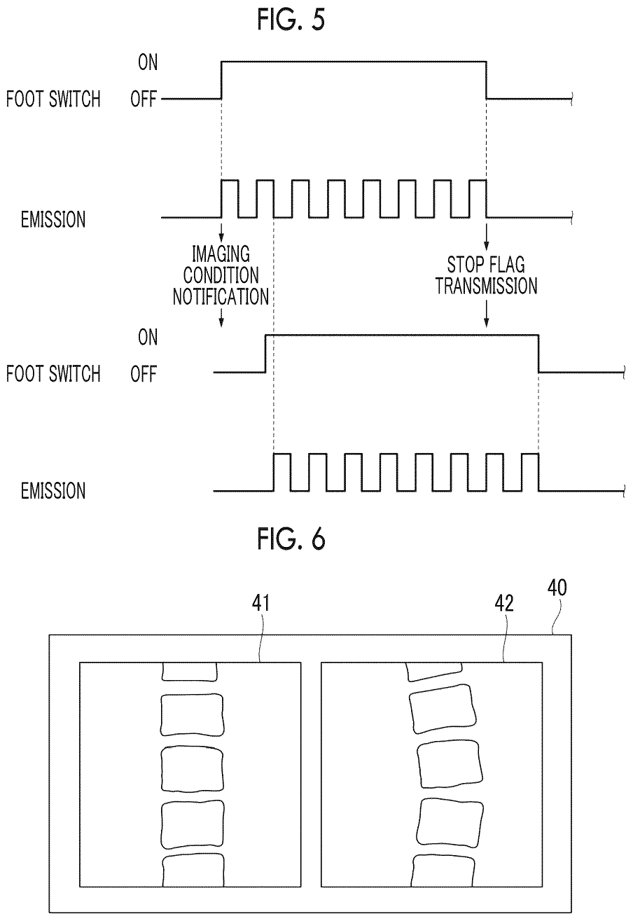

In a case where the imaging condition is notified, the imaging controller 31 of the fluoroscopy apparatus on the notified side controls the timing of irradiation with radiation in a case where the foot switch 13 is turned on. FIG. 5 is a diagram for describing a timing of irradiation with radiation. In FIG. 5, the timing of the radiation irradiation in a case where the foot switch 13 of the first fluoroscopy apparatus 1A is turned on first is illustrated, but the same applies to a case where the foot switch 13 of the second fluoroscopy apparatus 1B is turned on first.

The lateral axis of FIG. 5 is time, and shows, in order from the top, on/off of the foot switch 13 of the first fluoroscopy apparatus 1A, the timing of the radiation emitted from the radiation source 6 by turning on the foot switch 13 of the first fluoroscopy apparatus 1A, on/off of the foot switch 13 of the second fluoroscopy apparatus 1B that has received the notification of the imaging condition, and the timing of the radiation emitted from the radiation source 6 by turning on the foot switch 13 of the second fluoroscopy apparatus 1B.

As shown in FIG. 5, in the present embodiment, in a case where the foot switch 13 of the first fluoroscopy apparatus 1A is turned on from an off state, the radiation is emitted in a pulsed manner from the radiation source 6. The notification unit 33 notifies the associatedly registered second fluoroscopy apparatus 1B of the imaging condition at a timing at which the foot switch 13 is turned on. In the first fluoroscopy apparatus 1A, the subject H is imaged. In the second fluoroscopy apparatus 1B, the notified imaging condition is stored in the storage 23.

In a case where the foot switch 13 is turned on in the second fluoroscopy apparatus 1B while the subject H is being imaged in the first fluoroscopy apparatus 1A as described above, the imaging controller 31 of the second fluoroscopy apparatus 1B derives the timing at which the emission of the pulsed radiation is stopped in the first fluoroscopy apparatus 1A based on the imaging condition stored in the storage 23 and notified from the first fluoroscopy apparatus 1A. Specifically, a timing at which the emission of the pulsed radiation is stopped is derived from the irradiation start time, the pulse rate, and the pulse width included in the imaging condition. Then, the imaging controller 31 of the second fluoroscopy apparatus 1B controls the radiation source 6 such that the radiation is emitted at a timing at which the emission of the pulsed radiation is stopped in the first fluoroscopy apparatus 1A.

As a result, as shown in FIG. 5, in the second fluoroscopy apparatus 1B, the radiation is not emitted immediately after the foot switch 13 is turned on, and the pulsed radiation is emitted at a timing at which the emission of the pulsed radiation is stopped in the first fluoroscopy apparatus 1A. As a result, the first fluoroscopy apparatus 1A and the second fluoroscopy apparatus 1B alternately irradiate the subject H with radiation in a pulsed manner, and the subject H is imaged.

On the other hand, in the first fluoroscopy apparatus 1A, in a case where the foot switch 13 is turned off, the emission of radiation is stopped, and the notification unit 33 transmits a flag indicating that the emission of radiation has been stopped to the associatedly registered second fluoroscopy apparatus 1B. In this case, in a case where the imaging by the second fluoroscopy apparatus 1B is not performed, the second fluoroscopy apparatus 1B may discard the imaging condition stored in the storage 23. After the flag indicating that the emission of the radiation has been stopped is received, in the second fluoroscopy apparatus 1B, in a case where the foot switch 13 is turned on, the subject H which is radiated with the radiation from the radiation source 6 is immediately imaged.

The display controller 34 displays the fluoroscopic images acquired by the first and second fluoroscopy apparatuses 1A and 1B on the display 24. FIG. 6 is a diagram showing a display screen of fluoroscopic images. As shown in FIG. 6, a fluoroscopic image 41 acquired by the first fluoroscopy apparatus 1A and a fluoroscopic image 42 acquired by the second fluoroscopy apparatus 1B are displayed side by side on a display screen 40. The fluoroscopic image 41 is a front image of the subject H, and the fluoroscopic image 42 is a side image of the subject H. Although it is preferable that the two fluoroscopic images 41 and 42 are displayed side by side on the display 24 of both of the fluoroscopy apparatuses 1A and 1B, they may be displayed side by side on the display 24 of either one of the fluoroscopy apparatuses 1A or 1B.

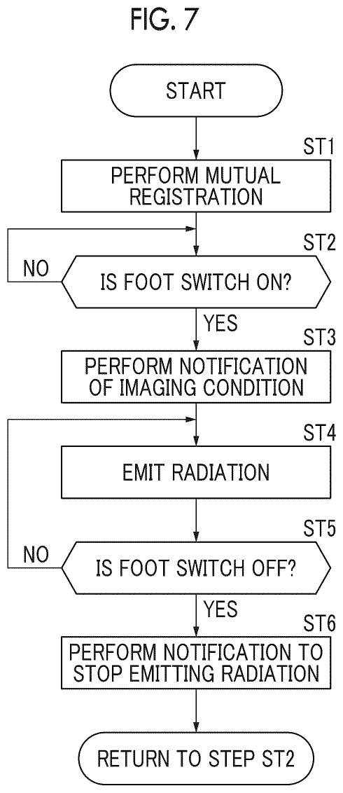

Next, processing performed in the present embodiment will be described. FIG. 7 is a flowchart showing the processing performed in the present embodiment. FIG. 7 shows only the processing performed in one of the first fluoroscopy apparatus 1A or the second fluoroscopy apparatus 1B. First, the registration unit 32 performs pairing to register the first fluoroscopy apparatus 1A and the second fluoroscopy apparatus 1B in association with each other (Step ST1).

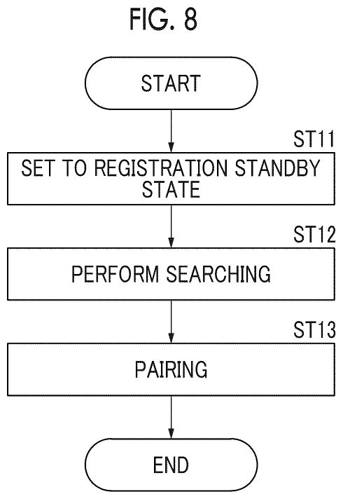

FIG. 8 is a flowchart showing associated registration processing. The registration unit 32 sets the fluoroscopy apparatus, in which the registration unit 32 itself is provided, to a registration standby state (Step ST11). Next, the registration unit 32 searches for another fluoroscopy apparatus in the registration standby state (Step ST12). Then, the registration unit 32 performs pairing with the found other fluoroscopy apparatus (Step ST13), thereby registering the fluoroscopy apparatus, in which the registration unit 32 itself is provided and the found other fluoroscopy apparatus in association with each other, and ends the associated registration processing.

Referring back to FIG. 7, next, the imaging controller 31 starts monitoring whether or not an instruction to start emitting radiation has been given by turning on the foot switch 13 (Step ST2). In a case where a determination result in Step ST2 is “Yes”, the notification unit 33 notifies the other fluoroscopy apparatus of the imaging condition (Step ST3). Then, the imaging controller 31 emits the pulsed radiation from the radiation source 6 (Step ST4). Accordingly, the subject H is imaged.

Subsequently, the imaging controller 31 determines whether or not an instruction to stop the emission of the radiation has been given by turning off the foot switch 13 (Step ST5). In a case where a determination result in Step ST5 is “No”, the processing returns to Step ST4. In a case where a determination result in Step ST5 is “Yes”, the imaging controller 31 stops the emission of the radiation, the notification unit 33 notifies that the emission of the radiation is stopped (Step ST6), and the processing returns to Step ST2.

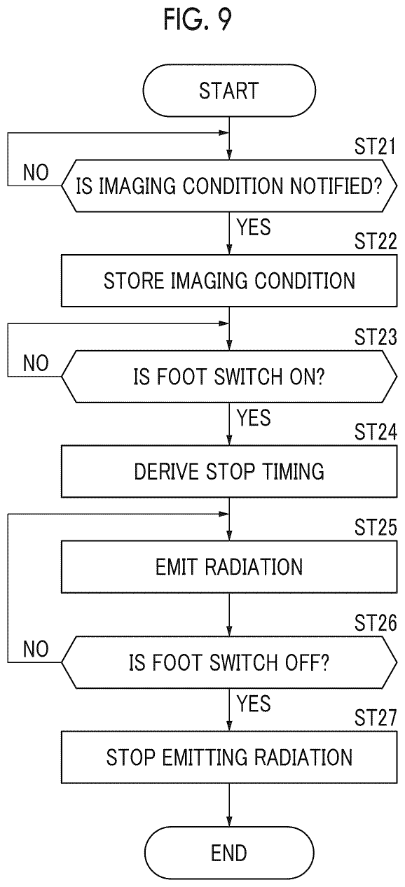

FIG. 9 is a flowchart showing processing performed in the fluoroscopy apparatus on the side to which the imaging condition is notified in the present embodiment. Here, the description will be made on the assumption that the imaging condition is notified to the second fluoroscopy apparatus 1B. It is assumed that the associated registration of the first and second fluoroscopy apparatuses 1A and 1B has been completed. It is monitored whether or not the imaging condition is notified from the first fluoroscopy apparatus 1A (Step ST21), and in a case where a determination result in Step ST21 is “Yes”, the notified imaging condition is stored in the storage 23 (Step ST22).

Next, the imaging controller 31 starts monitoring whether or not an instruction to start emitting radiation has been given by turning on the foot switch 13 (Step ST23). In a case where a determination result in Step ST23 is “Yes”, the imaging controller 31 derives the timing at which the emission of the pulsed radiation is stopped in the first fluoroscopy apparatus 1A based on the imaging condition stored in the storage 23 (stop timing derivation: Step ST24). Then, the imaging controller 31 emits the pulsed radiation from the radiation source 6 at a timing at which the emission of the pulsed radiation is stopped in the first fluoroscopy apparatus 1A (Step ST25). Accordingly, the subject H is imaged.

Subsequently, the imaging controller 31 determines whether or not an instruction to stop the emission of the radiation has been given by turning off the foot switch 13 (Step ST26). In a case where a determination result in Step ST26 is “No”, the processing returns to Step ST25. In a case where a determination result in Step ST26 is “Yes”, the imaging controller 31 stops the emission of the radiation from the radiation source 6 (Step ST27), and ends the processing.

In this way, in the present embodiment, in a case where a plurality of fluoroscopy apparatuses are simultaneously used to perform fluoroscopy of a subject in a plurality of directions, the plurality of fluoroscopy apparatuses are registered in association with each other, and in a case where radiation is emitted, the other fluoroscopy apparatus receives a notification of the imaging condition. In another fluoroscopy apparatus, in a case where an instruction to start imaging is given, a timing at which the emission of the pulsed radiation is stopped in the fluoroscopy apparatus that has notified the imaging condition is derived based on the imaging condition. Then, at a timing at which the emission of the pulsed radiation is stopped in the fluoroscopy apparatus that has notified the imaging condition, the pulsed radiation is emitted.

Therefore, it is possible to reduce an influence of radiation emitted from another fluoroscopy apparatus in a case where fluoroscopy is performed at timings different from each other using a plurality of fluoroscopy apparatuses. For example, it is possible to reduce the influence of scattered rays scattered in the subject by radiation emitted in another fluoroscopy apparatus.

In the above embodiment, an example in which two fluoroscopy apparatuses 1A and 1B are used has been described. However, it goes without saying that the technology of the present disclosure can be applied even in a case where three or more fluoroscopy apparatuses are used.

In addition, the radiation in the embodiment described above is not particularly limited, and α-rays or γ-rays can be applied in addition to X-rays.

In addition, in the above-described embodiment, for example, the following various processors can be used as a hardware structure of processing unit that executes various types of processing, such as the imaging controller 31, the registration unit 32, the notification unit 33, and the display controller 34. As described above, the various processors include a programmable logic device (PLD) which is a processor of which the circuit configuration can be changed after manufacture, such as a field-programmable gate array (FPGA), a dedicated electrical circuit which is a processor having a dedicated circuit configuration for executing specific processing such as an application-specific integrated circuit (ASIC), and the like, in addition to the CPU which is a general-purpose processor that functions as various processing units by executing software (program).

One processing unit may be configured by one of the various processors or a combination of two or more processors of the same type or different types (for example, a combination of a plurality of FPGAs or a combination of a CPU and an FPGA). In addition, a plurality of processing units may be configured by one processor.

As an example where a plurality of processing units are configured by one processor, first, there is a form in which one processor is configured by a combination of one or more CPUs and software as typified by a computer, such as a client or a server, and this processor functions as a plurality of processing units. Second, there is a form in which a processor for realizing the function of the entire system including a plurality of processing units via one integrated circuit (IC) chip as typified by a system on chip (SoC) or the like is used. As described above, various processing units are configured by using one or more of the various processors as a hardware structure.

Furthermore, as the hardware structure of the various processors, more specifically, an electric circuit (circuitry) in which circuit elements such as semiconductor elements are combined can be used.

The supplementary notes of the present disclosure will be described below.

### Supplementary Note 1

An imaging control device that controls fluoroscopy of a subject with a pulsed radiation from a plurality of directions, in each of a plurality of fluoroscopy apparatuses used simultaneously, in a case of performing the fluoroscopy, the imaging control device comprising:
at least one processor,
wherein the processor is configured to:
   register the fluoroscopy apparatus of which the processor itself controls the fluoroscopy and another fluoroscopy apparatus other than the fluoroscopy apparatus in association with each other;
   notify the other fluoroscopy apparatus of an imaging condition with the pulsed radiation in a case where an instruction to start emitting radiation is given in the fluoroscopy apparatus of which the processor itself controls the fluoroscopy; and
   control, in a case where the imaging condition is notified from the other fluoroscopy apparatus in a case where the instruction to start emitting the radiation is not given in the fluoroscopy apparatus of which the processor itself controls the fluoroscopy, and then the instruction to start emitting the radiation is given, the fluoroscopy to emit the pulsed radiation, at a timing at which the emission of the pulsed radiation is stopped in the other fluoroscopy apparatus, based on the imaging condition.

### Supplementary Note 2

The imaging control device according to Supplementary Note 1,
wherein the processor is configured to:
   set the fluoroscopy apparatus of which the imaging control device itself controls the fluoroscopy to a registration standby state;
   search for the other fluoroscopy apparatus in a registration standby state; and
   register the fluoroscopy apparatus of which the processor itself controls the fluoroscopy and the found other fluoroscopy apparatus in association with each other.

### Supplementary Note 3

The imaging control device according to Supplementary Note 1 or 2,
wherein the instruction to start emitting the radiation is given by turning on a radiation irradiation switch of the fluoroscopy apparatus.

### Supplementary Note 4

The imaging control device according to any one of Supplementary Notes 1 to 3,
wherein the processor is configured to notify, in a case where an instruction to stop emitting the radiation is given, the other fluoroscopy apparatus that the emission of the radiation is stopped.

### Supplementary Note 5

The imaging control device according to Supplementary Note 4,
wherein the instruction to stop emitting the radiation is given by turning off a radiation irradiation switch of the fluoroscopy apparatus, and
the processor is configured to notify the other fluoroscopy apparatus that the emission of the radiation is stopped by transmitting a radiation emission stop flag to the other fluoroscopy apparatus.

### Supplementary Note 6

An imaging control method for controlling fluoroscopy of a subject with a pulsed radiation from a plurality of directions, in each of a plurality of fluoroscopy apparatuses used simultaneously, in a case of performing the fluoroscopy, the method comprising:
via a computer,
registering the fluoroscopy apparatus of which the computer itself controls the fluoroscopy and another fluoroscopy apparatus other than the fluoroscopy apparatus in association with each other;
notifying the other fluoroscopy apparatus of an imaging condition with the pulsed radiation in a case where an instruction to start emitting radiation is given in the fluoroscopy apparatus of which the computer itself controls the fluoroscopy; and
controlling, in a case where the imaging condition is notified from the other fluoroscopy apparatus in a case where the instruction to start emitting the radiation is not given in the fluoroscopy apparatus of which the computer itself controls the fluoroscopy, and then the instruction to start emitting the radiation is given, the fluoroscopy to emit the pulsed radiation, at a timing at which the emission of the pulsed radiation is stopped in the other fluoroscopy apparatus, based on the imaging condition.

### Supplementary Note 7

An imaging control program that causes a computer to execute a process of controlling fluoroscopy of a subject with a pulsed radiation from a plurality of directions, in each of a plurality of fluoroscopy apparatuses used simultaneously, in a case of performing the fluoroscopy, the imaging control program causing a computer to execute:
a process of registering the fluoroscopy apparatus of which the computer itself controls the fluoroscopy and another fluoroscopy apparatus other than the fluoroscopy apparatus in association with each other;
a process of notifying the other fluoroscopy apparatus of an imaging condition with the pulsed radiation in a case where an instruction to start emitting radiation is given in the fluoroscopy apparatus of which the computer itself controls the fluoroscopy; and
a process of controlling, in a case where the imaging condition is notified from the other fluoroscopy apparatus in a case where the instruction to start emitting the radiation is not given in the fluoroscopy apparatus of which the computer itself controls the fluoroscopy, and then the instruction to start emitting the radiation is given, the fluoroscopy to emit the pulsed radiation, at a timing at which the emission of the pulsed radiation is stopped in the other fluoroscopy apparatus, based on the imaging condition.

What is claimed is:

1. An imaging control device that, in a case of performing fluoroscopy of a subject with a pulsed radiation from a plurality of directions, controls the fluoroscopy in each of a plurality of fluoroscopy apparatuses used simultaneously, the imaging control device comprising:
at least one processor,
wherein the processor is configured to:
register the fluoroscopy apparatus of which the processor itself controls the fluoroscopy and another fluoroscopy apparatus other than the fluoroscopy apparatus in association with each other;
notify the other fluoroscopy apparatus of an imaging condition with the pulsed radiation in a case where an instruction to start emitting radiation is given in the fluoroscopy apparatus of which the processor itself controls the fluoroscopy; and
control, in a case where the imaging condition is notified from the other fluoroscopy apparatus in a case where the instruction to start emitting the radiation is not given in the fluoroscopy apparatus of which the processor itself controls the fluoroscopy, and then the instruction to start emitting the radiation is given, the fluoroscopy to emit the pulsed radiation, at a timing at which the emission of the pulsed radiation is stopped in the other fluoroscopy apparatus, based on the imaging condition.

2. The imaging control device according to claim 1,
wherein the processor is configured to:
set the fluoroscopy apparatus of which the processor itself controls the fluoroscopy to a registration standby state;
search for the other fluoroscopy apparatus in a registration standby state; and
register the fluoroscopy apparatus of which the processor itself controls the fluoroscopy and the found other fluoroscopy apparatus in association with each other.

3. The imaging control device according to claim 1,
wherein the instruction to start emitting the radiation is given by turning on a radiation irradiation switch of the fluoroscopy apparatus.

4. The imaging control device according to claim 2,
wherein the instruction to start emitting the radiation is given by turning on a radiation irradiation switch of the fluoroscopy apparatus.

5. The imaging control device according to claim 1,
wherein the processor is configured to notify, in a case where an instruction to stop emitting the radiation is given, the other fluoroscopy apparatus that the emission of the radiation is stopped.

6. The imaging control device according to claim 2,
wherein the processor is configured to notify, in a case where an instruction to stop emitting the radiation is given, the other fluoroscopy apparatus that the emission of the radiation is stopped.

7. The imaging control device according to claim 3,
wherein the processor is configured to notify, in a case where an instruction to stop emitting the radiation is given, the other fluoroscopy apparatus that the emission of the radiation is stopped.

8. The imaging control device according to claim 5,
wherein the instruction to stop emitting the radiation is given by turning off a radiation irradiation switch of the fluoroscopy apparatus, and
the processor is configured to notify the other fluoroscopy apparatus that the emission of the radiation is stopped by transmitting a radiation emission stop flag to the other fluoroscopy apparatus.

9. The imaging control device according to claim 6,
wherein the instruction to stop emitting the radiation is given by turning off a radiation irradiation switch of the fluoroscopy apparatus, and
the processor is configured to notify the other fluoroscopy apparatus that the emission of the radiation is stopped by transmitting a radiation emission stop flag to the other fluoroscopy apparatus.

10. The imaging control device according to claim 7,
wherein the instruction to stop emitting the radiation is given by turning off a radiation irradiation switch of the fluoroscopy apparatus, and
the processor is configured to notify the other fluoroscopy apparatus that the emission of the radiation is stopped by transmitting a radiation emission stop flag to the other fluoroscopy apparatus.

11. An imaging control method for controlling fluoroscopy of a subject with a pulsed radiation from a plurality of directions, in each of a plurality of fluoroscopy apparatuses used simultaneously, in a case of performing the fluoroscopy, the method comprising:
via a computer,
registering the fluoroscopy apparatus of which the computer itself controls the fluoroscopy and another fluoroscopy apparatus other than the fluoroscopy apparatus in association with each other;
notifying the other fluoroscopy apparatus of an imaging condition with the pulsed radiation in a case where an instruction to start emitting radiation is given in the fluoroscopy apparatus of which the computer itself controls the fluoroscopy; and
controlling, in a case where the imaging condition is notified from the other fluoroscopy apparatus in a case where the instruction to start emitting the radiation is not given in the fluoroscopy apparatus of which the computer itself controls the fluoroscopy, and then the instruction to start emitting the radiation is given, the fluoroscopy to emit the pulsed radiation, at a timing at which the emission of the pulsed radiation is stopped in the other fluoroscopy apparatus, based on the imaging condition.

12. A non-transitory computer-readable storage medium that stores an imaging control program that causes a computer to execute a process of controlling fluoroscopy of a subject with a pulsed radiation from a plurality of directions, in each of a plurality of fluoroscopy apparatuses used simultaneously, in a case of performing the fluoroscopy, the imaging control program causing the computer to execute:
a process of registering the fluoroscopy apparatus of which the computer itself controls the fluoroscopy and another fluoroscopy apparatus other than the fluoroscopy apparatus in association with each other;
a process of notifying the other fluoroscopy apparatus of an imaging condition with the pulsed radiation in a case where an instruction to start emitting radiation is given in the fluoroscopy apparatus of which the computer itself controls the fluoroscopy; and
a process of controlling, in a case where the imaging condition is notified from the other fluoroscopy apparatus in a case where the instruction to start emitting the radiation is not given in the fluoroscopy apparatus of which the computer itself controls the fluoroscopy, and then the instruction to start emitting the radiation is given, the fluoroscopy to emit the pulsed radiation, at a timing at which the emission of the pulsed radiation is stopped in the other fluoroscopy apparatus, based on the imaging condition.
